(19) United States
(12) Patent Application Publication
(10) Pub. No.: US 2008/0042822 A1
(43) Pub. Date: Feb. 21, 2008

(54) Indicating light of a car

(76) Inventor: Alan Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/500,329

(22) Filed: Aug. 8, 2006

(51) Int. Cl. B60Q 7/02

(52) U.S. Cl. 340/472

(57) ABSTRACT

An indicating light of a car has an indicating device, which is securely fitted on a rear side of a car, and which consists of several different indicating light sections; the different indicating light sections have different colored light sources thereon therefore each of the indicating light sections will emit a respective colored light to indicate a particular situation, e.g. braking, reversing, turning, and emergency; in other words, the indicating light can serve several purposes instead of single one.

### BACKGROUND OF THE INVENTION

1. Field of the Invention

The present invention relates to an indicating light of a car, more particularly one, which consists of several different indicating light sections having different colored light sources such that each of the indicating light sections will emit a respective colored light to indicate a particular situation, thus helping make driving safer.

2. Brief Description of the Prior Art

More than one hundred years have passed since first motor vehicles were invented. The quantity of motor currently existing motor vehicles is many times more than that of early motor vehicles. And, modern motor vehicles can run much faster than early ones. However, there hasn't been significant improvement made on the safety-related indicating systems of motor vehicles in one hundred years.

Common motor vehicles are equipped with headlights, parking lights, tail-lights, reversing lights, blinkers, and brake lights; the headlight is used to provide illumination in the dark while the reversing lights, the blinkers, and the brake lights will shine to alert other people and drivers in various situations so as to make driving safer.

However, the various indicating lights of a common car are arranged on the body of the car therefore the indicating lights are lower than drivers' line of sight, and could become invisible to the drivers of other cars when the former is very close to other cars. Consequently, accidents are prone to happen.

To overcome the above-mentioned problem, a supplementary brake light is fitted on a rear window of a car so as to be as high as drivers' line of sight. Therefore, the drivers of other cars behind will easily see the signals from the supplementary brake light. However, the supplementary brake light can only indicate that the driver is braking. In other words, it can serve single purpose, and there are still no supplementary lights available to indicate other situations such as turning, reversing, and emergency.

### SUMMARY OF THE INVENTION

It is a main object of the invention to provide an improvement on an indicating light of a car to overcome the above-mentioned problems. The indicating light of the present invention has an indicating device, which is securely fitted on a rear side of a car, and which consists of several different indicating light sections. The different indicating light sections have different colored light sources thereon therefore each of the indicating light sections will emit a respective colored light to indicate a particular situation such as brake, reversing, turning, and emergency. Consequently, the indicating light will serve more purposes, and help make driving safer.

### BRIEF DESCRIPTION OF THE DRAWINGS

The present invention will be better understood by referring to the accompanying drawings, wherein:

FIG. 1 is a front view of the present invention,

FIG. 2 is a circuit diagram in the present invention,

FIG. 3 is a view of the present invention, taken when it is fitted on a rear window of a car, and

FIG. 4 is a view of the present invention, taken when it is fitted on a trunk cover of a car.

### DETAILED DESCRIPTION OF THE PREFERRED EMBODIMENTS

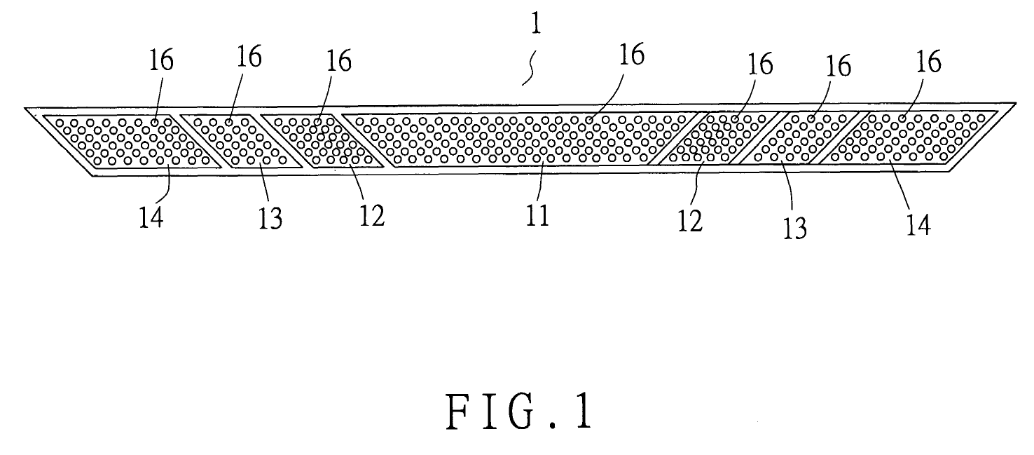

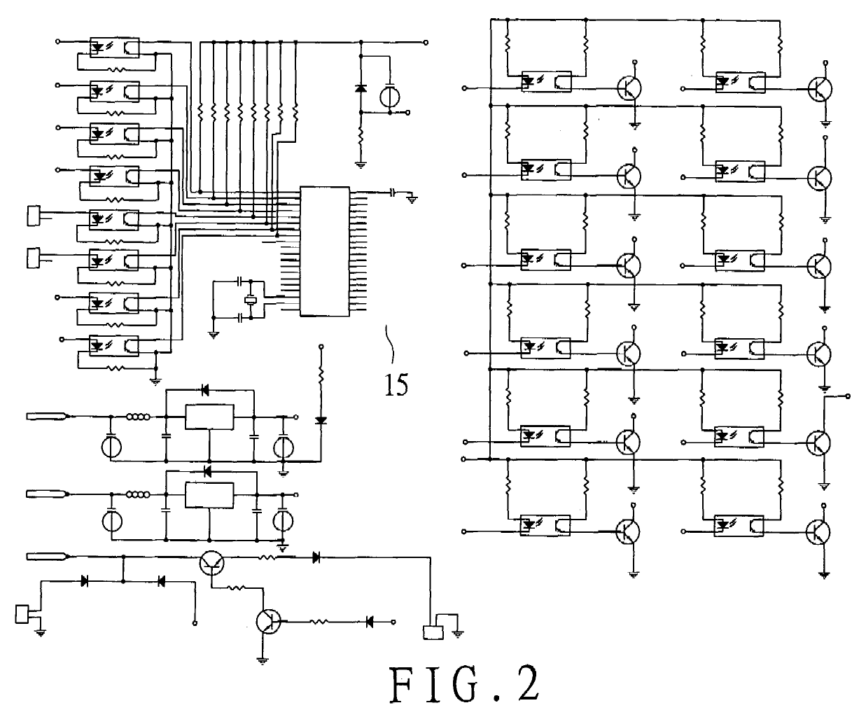

Referring to FIGS. 1 and 2, a preferred embodiment of an indicating light of a car comprises an indicating device 1, which can be a lamp base or a film-type lamp, and which consists of a brake indicating light section 11, two back-up indicating light sections 12, two warning light sections 13, two direction indicating light sections 14, and a control circuit 15 used for controlling the brake indicating light section 11, the back-up indicating light sections 12, the warning light sections 13, and the direction indicating light sections 14. The brake indicating light section 11, the back-up indicating light sections 12, the warning light sections 13, and the direction indicating light sections 14 each have several light sources 16, which can be light emitting diodes (LED). The control circuit 15 can be connected to and powered with a storage battery of a motor vehicle. Or alternatively, the control circuit 15 can be connected to and powered with another battery.

The light sources 16 of the brake indicating light section 11 can emit red light. The light sources 16 of the back-up indicating light sections 12 can emit white light. The light sources 16 of the warning light sections 13 can emit blue light and red light. And, the light sources 16 of the direction indicating light sections 14 can emit yellow light.

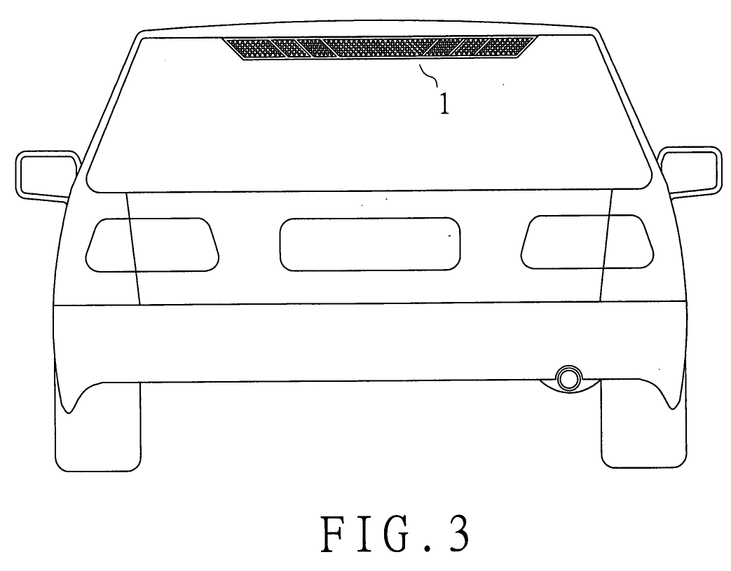

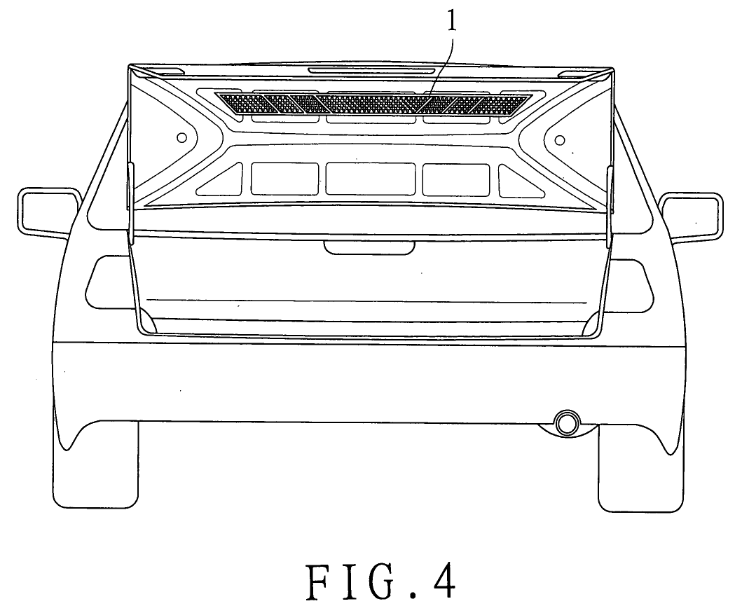

The indicating light base 1 is fitted on a rear window of a car, as shown in FIG. 3, or an upper end of a trunk cover of a car, as shown in FIG. 4. Therefore, when the driver presses the brake pedal, the light sources 16 of the brake indicating light section 11 will start emitting red light to alert drivers behind. When the driver turn on a blinker of the car before turning, the light sources 16 of the corresponding blinker section 14 will start emitting yellow light to alert drivers behind. When the driver shifts to reverse gear before reversing, the light sources 16 of the back-up indicating light sections 13 will start emitting white light to alert people and drivers behind. If emergency happens such as breakdown of the car when the car is being driven, the driver is allowed to turn on the warning light sections 13 for the warning light sections 13 to emit red light and blue light in an alternating manner to make other people and drivers notice.

From the above description, it can be seen that the indicating light of the present invention has an advantage over the conventional one; it consists of several different sections each capable of emitting a respective colored light to indicate a particular situation. Consequently, the present invention can serve several different purposes, and help increase safety of driving.

What is claimed is:

1. An indicating light of a car, comprising
an indicating device, said indicating device consisting of:
a plurality of different indicating light sections, said indicating light sections having different colored light sources thereon; and
a control circuit connected to and controlling said indicating light sections.

2. The indicating light of a car as recited in claim 1, wherein said indicating device is a lamp base.

3. The indicating light of a car as recited in claim 1, wherein aid indicating device is a film-type lamp.

4. The indicating light of a car as recited in claim 1, wherein said different indicating light sections include a brake indicating light section, a back-up indicating light section, a warning light section, and a direction indicating light section.

5. The indicating light of a car as recited in claim 1, wherein said light sources are light emitting diodes.

6. The indicating light of a car as recited in claim 1, wherein said indicating device is fitted on a rear window of a car.

7. The indicating light of a car as recited in claim 1, wherein said indicating device is fitted on an upper end of a trunk cover of a car.

8. The indicating light of a car as recited in claim 1, wherein said indicating device is powered with a storage battery of a car.

9. The indicating light of a car as recited in claim 1, wherein said indicating device is powered with a battery.

10. The indicating light of a car as recited in claim 2, wherein said light sources of said brake indicating light section are red ones, said light sources of said back-up indicating light section are white ones, said light sources of said warning light section include blue and red ones, and said light sources of said direction indicating light section are yellow ones.
